(19) United States
(12) Patent Application Publication
(10) Pub. No.: US 2010/0116084 A1
(43) Pub. Date: May 13, 2010

(54) Liner and cable construction

(75) Inventor: Werner H. Steuernagel, New Philadelphia, OH (US)

Correspondence Address: SAND & SEBOLT, AEGIS TOWER, SUITE 1100, 4940 MUNSON STREET, NW, CANTON, OH, 44718-3615, US

(73) Assignee: Cable Manufacturing & Assembly, Inc., New Philadelphia, OH (US)

(21) Appl. No.: 12/291,446

(22) Filed: Nov. 10, 2008

(51) Int. Cl. F16C 1/26; F16C 1/10

(52) U.S. Cl. 74/502.5

(57) ABSTRACT

A push-pull cable having an inner member, an outer member surrounding and integral to the inner member and having an outer surface, and a sheath having an inner surface, wherein the inner surface is serrated. A push-pull cable including an inner member having an outside diameter of 360 degrees of frictional engagement surface and an outer member having an inside diameter of less than 360 degrees of frictional engagement surface, wherein the inner member outside diameter is frictionally engaged with the outer member inside diameter.

### BACKGROUND OF THE INVENTION

1. Technical Field

The invention relates generally to push-pull cables. More particularly, the invention relates to push-pull cables with a more efficient push-pull cable sheath and cable arrangement. Specifically, the invention relates to a push-pull cable with substantially less frictional resistance between the cable and the sheath to reduce the effort required to operate the cable while still maintaining complete functionality.

2. Background Information

A cable is generally an elongated cluster of wires which are bound together to perform a function, such as move an object, transmit data, or carry electrical current. Mechanical cables are used to impart movement in an object from a remote location. A throttle cable is a prime example of a mechanical cable as it connects the accelerator pedal, or lever for a boat throttle, and the engine intake throttle body. Movement of the lever in one direction results in movement at the throttle body in the same direction. Thus, a mechanical cable allows control of movement in two directions which are opposite of one another.

Cables provide distinctive advantages over rods and other devices which can move an object from a remote place. Initially, cables are flexible and can be routed in tight spaces and odd places. Unlike rods which are ridged, stranding of wires to produce a cable achieves a thicker cable with the flexibility of a thinner cable. The increased flexibility allows the cable to be routed around corners and objects which a ridged rod could not. Further, the cable is usually protected from the environment with a coating or sheath around the outer periphery of the cable. The sheath may also provide protection from fire if the sheath is composed of a fire retardant material. Thus, the cable is protected from the environment and flexible enough to be routed in tight spaces.

While cables provide advantages over rods, the cable also has a major drawback that the rod does not suffer from. While a rod has essentially one-to-one effort requirements, a cable does not. In particular, each pound of force imparted on the rod translates into essentially the same force output from the rod. While a cable, on the other hand, suffers from a great deal of frictional loss. In particular, the inner member of a push-pull cable slides within the outer member and the frictional engagement between the inner member and the outer member produces a loss of energy.

To the end user, the loss of energy means that the cable must be pushed or pulled harder in order to achieve the same end results. While the additional energy may be trivial for short cables, long cables may require substantial increases in the force necessary. Further, the frictional forces provide more opportunity for the cable to bind, especially-in the push direction.

Thus there is a long-felt need for a push-pull cable with reduced friction between the cable and the sheath that still provides the consistency and accuracy of the common mechanical cable.

### SUMMARY OF THE INVENTION

The present invention broadly comprises a push-pull cable including an inner cable, a sheath having an inner surface, and wherein the inner surface of the sheath is formed with protrusions thereon.

The present invention also broadly comprises a push-pull cable including an inner member having an outer surface with an outside diameter of 360 degrees of frictional engagement surface, an outer member having an inner surface with an inside diameter of less than 360 degrees of frictional engagement surface, and wherein the inner member outer surface is frictionally engaged with the outer member inner surface.

### BRIEF DESCRIPTION OF THE DRAWINGS

The preferred embodiment of the invention, illustrative of the best mode in which the Applicants have contemplated applying the principles of the invention, are set forth in the following description and are shown in the drawings.

FIG. 1 is a perspective view of a preferred embodiment push-pull cable integrated into a boat as the throttle control cable;

FIG. 2 is a side view of a preferred embodiment push-pull cable connected to a throttle and a portion of the outer coating and sheath removed to show the inner cable;

FIG. 3 is a cross-sectional view of the push-pull cable of FIG. 2 taken generally about line 3-3;

FIG. 4 is a cross-sectional view of a preferred embodiment push-pull cable sheath;

FIG. 5 is a front view of a preferred embodiment push-pull cable sheath; and,

FIG. 6 is a front view of a second preferred embodiment push-pull cable sheath.

### DESCRIPTION OF THE PREFERRED EMBODIMENTS

At the outset, it should be appreciated that like drawing numbers on different drawing views identify identical, or functionally similar, structural elements of the invention. While the present invention is described with respect to what is presently considered to be the preferred embodiments, it is to be understood that the invention as claimed is not limited to the disclosed aspects.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

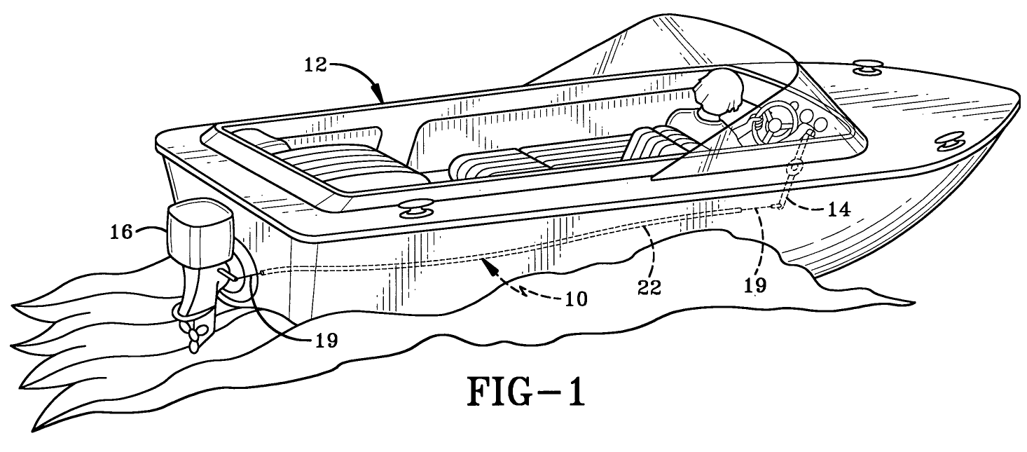

The push-pull cable of the present invention is indicated generally at 10, as is particularly shown in FIGS. 1 through 5. As particularly shown in FIG. 1, a preferred embodiment push-pull cable 10 is shown integrated on a boat 12. In particular, the cable is seen connecting throttle lever 14 and engine 16 and runs from the front end of the boat to the back end of the boat.

Averting to FIG. 2, push-pull cable 10 is attached to throttle lever 14 with connector 17 and the push-pull cable includes an inner cable 18, an outer coating 20, and a sheath 22. In a preferred embodiment, inner cable 18 is formed from a plurality of wires 18A spirally arranged around one another forming an outer surface 24. Further, the wires may be swaged together to form a single integral cable which is flexible like thin wire, but is sturdy enough to operate as a mechanical connection between two objects. In particular, the preferred embodiment inner cable is seven stainless steel wires swaged into a single inner cable. Although the present invention is described with seven wires formed from stainless steel, it is within the spirit and scope of the present invention to provide any number of wires formed from any other suitable material.

In accordance with one of the main features of the present invention, outer coating 20 completely surrounds inner cable 18 after the inner cable is swaged to form a coated inner cable 19. The outer coating is preferably extruded along the entire length of inner cable outer surface 24 and forms an outside surface 26 of the outer coating. The outer coating outside surface diameter will vary in thickness with the type of cable, but should be approximately equal to the inside diameter of sheath 22 so that the outer coating is frictionally engaged with the sheath. Preferably, the outer coating is composed of a low friction plastic material such as Nylon, although any low friction plastic may be incorporated and is within the spirit and scope of the invention as claimed. In addition, although the outer coating is described as being applied with an extrusion process, any suitable manufacturing process may be utilized to provide an outer coating with a generally circular outside surface.

Since inner cable 18 is preferably swaged to form a single cable, and outer coating 20 is extruded completely surrounding the inner cable, the inner cable and outer coating function as a single cable. Thus the single cable retains the flexibility of a plurality of wires and the low friction characteristics of Nylon, which allow the cable to provide both tensile and compressive linking with a low coefficient of friction and the ability to route the cable through tight spaces.

In accordance with another main feature of the present invention, sheath 22 surrounds outer coating 20 and preferably runs slightly less than the full length of outer coating 20. The sheath includes an inside surface 28 and an outside surface 30. In a preferred embodiment, outside surface 26 of the outer coating is smaller than inside surface 28 of the sheath.

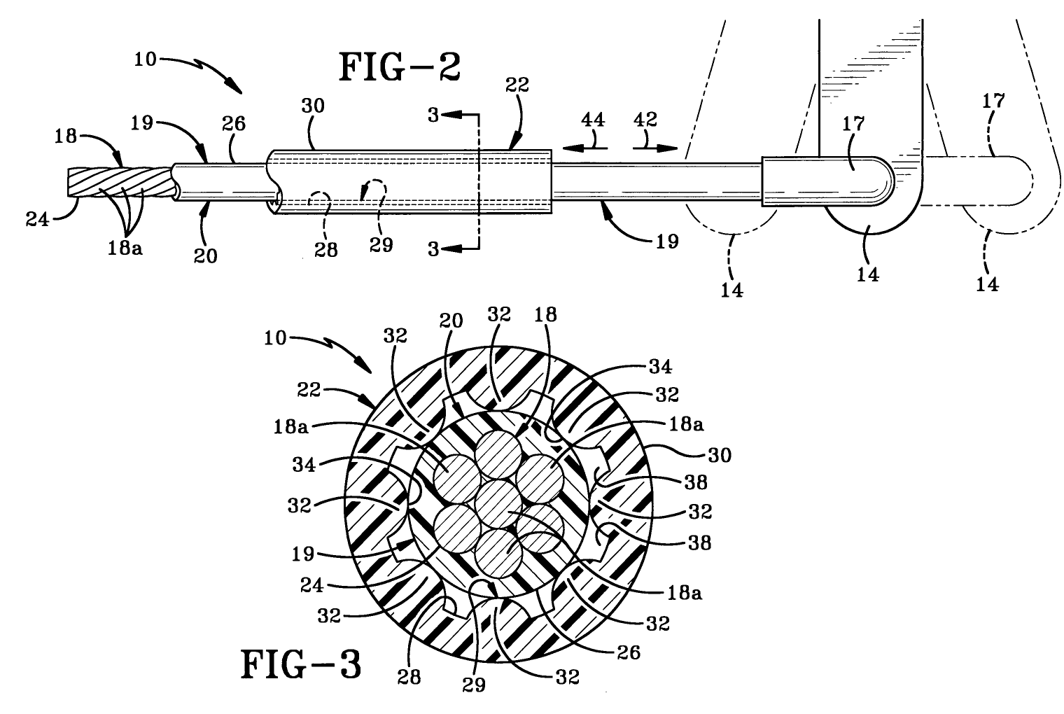

Averting to FIG. 3, inside surface 28 of sheath 22 is serrated in a preferred embodiment. Specifically, inside surface 28 includes a plurality of protrusions, or teeth, 32 extending radially inward from the inside surface. The protrusions each have a generally concave shape and are arranged at approximately forty-five degree intervals, although any interval may be utilized depending upon the protrusion arrangement and size. Between each protrusion, inside surface 28 maintains the circular shape, similar to outside surface 30. The protrusions each crest radially inward at tip 34 and provide a second inside surface 29 radially inward of inside surface 28. Accordingly, outer surface 26 of outer coating 20 is adjacent to and frictionally engaged with second inside surface 29 formed along tips 34 of protrusions 32. Further, since outer surface 26 is only frictionally engaged with tips 34 of protrusions 32, less than the entire inner surface of the sheath and outer surface 26 are frictionally engaged, and reduced friction is achieved.

Sheath 22 is preferably composed of a low friction plastic, such as high density polyethylene or similarly situated material. The sheath may also be only partially formed with the low friction plastic. For example, the inner surfaces and outer surface of the sheath may be different materials, so long as the inner most surface of the sheath is composed of a low friction plastic as previously described. In particular, the portion of sheath 22 which is frictionally engaged with outer coating must be composed of the low friction plastic to reduce the coefficient of friction in the push-pull cable.

FIG. 4 is a cross-sectional view of sheath 22 with the inner cable and outer coating removed. A valley 38 is located between each protrusion 32 and the base of the valley is maintained at inside surface 28. Accordingly, the inner cable slides though sheath 22 and contacts the sheath only along the radially inward surface at tips 34. While protrusions 32 are shown and described as generally concave or bowl-shaped, it is within the spirit and scope of the present invention to provide “V-shape” or any other suitable shape for the protrusions that reduces the contact area of the inner cable and the sheath.

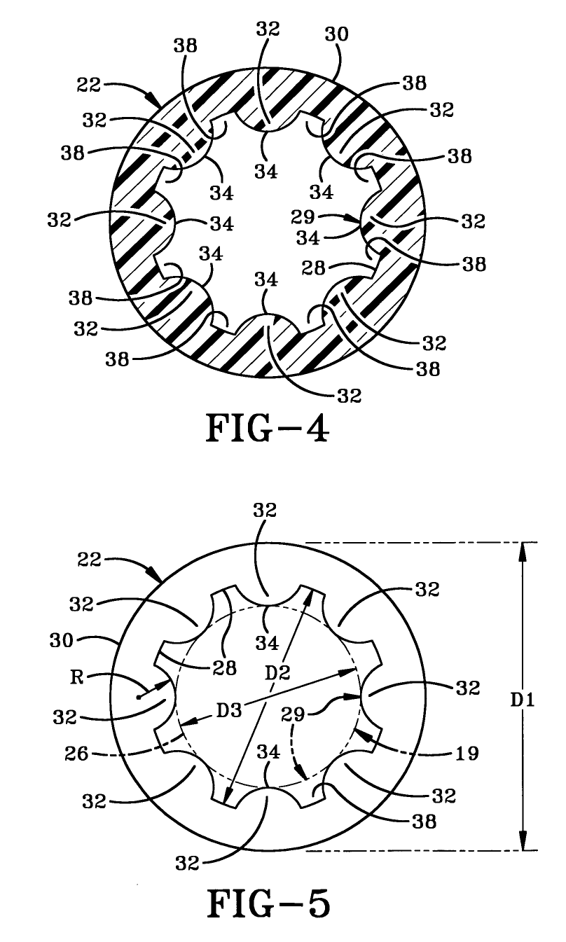

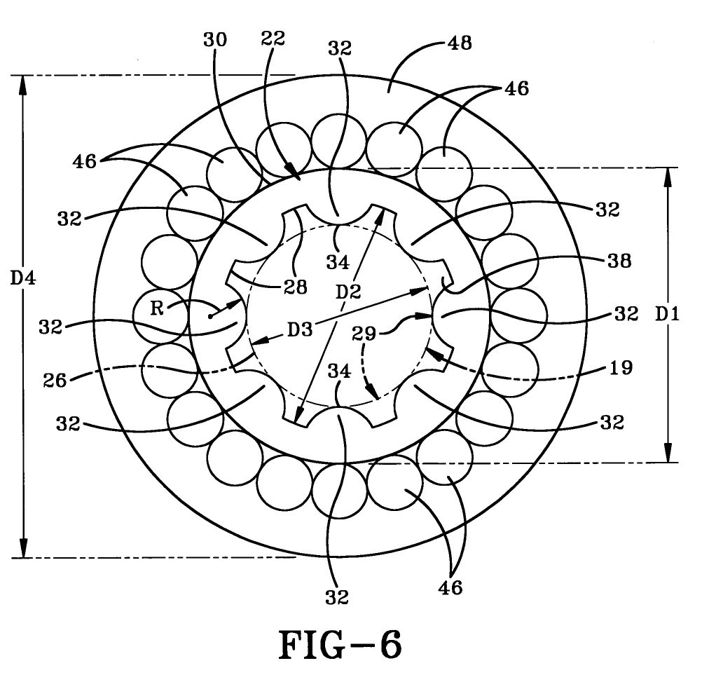

FIG. 5 is a front view of sheath 22 with the inner cable and outer coating removed. In a preferred embodiment, the push-pull cable has a circular cross-section, however any size or shape cross-section which is capable of providing a reliable interface between two mechanical objects is within the spirit and scope of the present invention.

In a first preferred embodiment, outer surface 30 of sheath 22 has an outside diameter D1 in the range of approximately 0.172 inches to 0.176 inches, an inside diameter D2, previously referred to as inside surface 28, in the range of approximately 0.126 inches to 0.136 inches, and a second inside diameter D3, previously referred to as second inside surface 29, in the range of approximately 0.107 inches to 0.111 inches. Further, each protrusion 32 has a radius R of approximately 0.024 inches.

In a second preferred embodiment, outer surface 30 of sheath 22 has an outside diameter D1 in the range of approximately 0.134 inches to 0.138 inches, an inside diameter D2, previously referred to as inside surface 28, in the range of approximately 0.103 inches to 0.113 inches, and a second inside surface D3, previously referred to as second inside surface 29, in the range of approximately 0.081 inches to 0.085 inches. Further, each protrusion 32 has a radius R of approximately 0.15 inches.

In summary, push-pull cable 10 includes inner cable 18 with an outside diameter with 360 degrees of a frictional engagement surface and sheath 22 with second inside surface 29 having less than 360 degrees of a frictional engagement surface. The two frictional engagement surfaces are in contact with one another and provide a reduced coefficient of friction due to the second inside diameter having less than 360 degrees of a frictional engagement surface.

Having described the structure of the preferred embodiments, a preferred method of operation will be described in detail and should be read in light of FIGS. 1 though 5.

Push-pull cable 10 operates by sliding inner cable 18, with outer coating 20, within sheath 22 in the directions associated with arrows 42 and 44. In particular, cable 10 is pushed in the direction of arrow 44 and pulled in the direction of arrow 42. Further, since sheath 22 includes protrusions 32, outer coating 20 is frictionally engaged with tips 34, which substantially reduces the contact area between the sheath and the outer coating. The reduction in contact area also reduces the energy lost when the cable is pushed or pulled through the sheath. Accordingly, the user will have to expend less energy to push or pull the cable. Also, the reduced friction means there is a smaller chance that the inner cable will bind during the push or pull motions.

Having described the structure and operation of the first and second preferred embodiments, only those portions of the remaining embodiments which are different from the first embodiment are described in detail. Likewise, similar numerals refer to similar parts throughout the various embodiments.

In accordance with another main feature of the present invention, FIG. 6 illustrates sheath 22 surrounded by a plurality of sheath lay wires 46, which are arranged in a spiral orientation around sheath 22. The sheath lay wires help to provide strength to the sheath while still allowing flexibility. Although any number of sheath lay wires 46 may be utilized, in the preferred embodiment there are approximately between 6 and 20 wires.

Further, a sheath cover 48 surrounds both sheath 22 and sheath lay wires 46 and forms the outer surface of the sheath with a diameter D4. Sheath cover 48 is preferably polypropylene or nylon, although any suitable material is within the spirit and scope of the present invention as claimed. The sheath cover is preferably extruded around sheath 22 and sheath lay wires 46 after the sheath lay wires are wrapped around the sheath.

Accordingly, the push-pull cable is an effective, safe, inexpensive, and efficient device that achieves all the enumerated objectives of the invention, provides for eliminating difficulties encountered with prior art devices, systems, and methods, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries, and principles of the invention, the manner in which the push-pull cable is constructed and used, the characteristics of the construction, and the advantageous new and useful results obtained; the new and useful structures, devices, elements, arrangement, parts, and combinations are set forth in the appended claims.

What is claimed is:

1. A push-pull cable comprising:
an inner cable;
a sheath having an inner surface; and,
wherein the inner surface of the sheath is formed with protrusions thereon.

2. The push-pull cable of claim 1 wherein the protrusions have a generally concave shape.

3. The push-pull cable of claim 1 wherein the protrusions are axial bosses extending the length of the sheath.

4. The push-pull cable of claim 1 wherein the protrusions are spaced apart from each other.

5. The push-pull cable of claim 4 wherein the protrusions are spaced apart at approximately forty-five degree intervals.

6. The push-pull cable of claim 1 wherein there are eight protrusions.

7. The push-pull cable of claim 1 further comprising an outer member extruded onto the inner cable.

8. The push-pull cable of claim 7 wherein the outer member is comprised of nylon.

9. The push-pull cable of claim 1 wherein the sheath is at least partially composed of a low friction plastic.

10. The push-pull cable of claim 9 wherein the low friction plastic is high density polyethylene.

11. The push-pull cable of claim 1 wherein the inner cable and the sheath each have a generally circular cross-section.

12. The push-pull cable of claim 1 wherein the sheath further comprises a second inner surface radially outward of the inner surface and the inner cable is frictionally engaged with the inner surface.

13. The push-pull cable of claim 12 wherein the second inner surface has an inside diameter in the range of approximately 0.103 to 0.113 inches and the inner surface has an inside diameter in the range of approximately 0.081 to 0.085 inches.

14. The push-pull cable of claim 12 wherein the second inner surface has an inside diameter in the range of approximately 0.126 to 0.136 inches and the inner surface has an inside diameter in the range of approximately 0.107 to 0.111 inches.

15. The push-pull cable of claim 1 wherein less than the entire inner surface and inner cable are frictionally engaged.

16. The push-pull cable of claim 1 wherein the sheath further comprises a longitudinal axis and the inner cable is frictionally engaged with the protrusions along the longitudinal axis of the sheath.

17. The push-pull cable of claim 1 wherein the sheath further comprises a plurality of sheath lay wires and a sheath cover, wherein the plurality of sheath lay wires are radially outward of the sheath and the sheath cover is generally radially outward of the sheath lay wires.

18. A push-pull cable comprising:
an inner member having an outer surface with an outside diameter of 360 degrees of frictional engagement surface;
an outer member having an inner surface with an inside diameter of less than 360 degrees of frictional engagement surface; and,
wherein the inner member outer surface is frictionally engaged with the outer member inner surface.

19. The push-pull cable of claim 18 wherein the inner member further comprises a plurality of inner wires spirally arranged around one another and an extruded coating surrounding the inner wires and forming the outer surface.

20. The push-pull cable of claim 19 wherein the extruded coating is composed of Nylon and the outer member inside diameter is composed of high density polyethylene.
